(19) United States
(12) Patent Application Publication
(10) Pub. No.: US 2026/0044436 A1
(43) Pub. Date: Feb. 12, 2026

(54) SYSTEMS AND METHODS FOR VISUAL PROGRAMMING

(71) Applicant: Salesforce, Inc., San Francisco, CA (US)

(72) Inventors: Artemis Panagopoulou, San Francisco, CA (US); Honglu Zhou, San Francisco, CA (US); Juan Carlos Niebles Duque, Mountain View, CA (US)

(21) Appl. No.: 18/972,463

(22) Filed: Dec. 6, 2024

Related U.S. Application Data
(60) Provisional application No. 63/681,721, filed on Aug. 9, 2024.

(51) Int. Cl. G06F 11/3668

(52) U.S. Cl. CPC G06F 11/3684; G06F 11/3688; G06F 11/3696

(57) ABSTRACT

Embodiments described herein provide for utilizing a large language model (LLM) to automatically generate unit tests, comprising image descriptions and expected answers for specified queries for use in visual programming. Further, text-to-image generation models are utilized to create images that align with the descriptions provided in each unit test. In some embodiments, a system executes only the top-scoring programs, reverts to a baseline model in cases of low scores, uses unit tests for re-prompting, and/or applies unit tests in reinforcement learning scenarios.

### CROSS REFERENCE(S)

The instant application is a nonprovisional of and claim priority under 35 U.S.C. 119 to U.S. provisional application No. 63/681,721, filed Aug. 9, 2024, which is hereby expressly incorporated by reference herein in its entirety.

### TECHNICAL FIELD

The embodiments relate generally to machine learning systems for visual programming, and more specifically to generating and utilizing unit tests in visual programming.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

In some systems, a language model is used to generate code which may be executed in order to generate a response to a question about a provided image (i.e., visual programming). Visual Programming, which involves generating executable programs that leverage specialist systems (e.g. object detection, captioning, etc.), may be used as a method for tackling compositional reasoning tasks, a long-standing challenge for modern vision systems. Supervised methods may improve the performance of visual program synthesis by leveraging programs that yield correct results on training data. Nevertheless, a synthesized program may produce the correct output, even if its underlying logic is flawed. This leads to non-transferable and unreliable code, as well as a difficulty in generating good training data. Therefore, there is a need for improved systems and methods for visual programming.

### BRIEF DESCRIPTION OF THE DRAWINGS

FIG. 1 is a simplified diagram illustrating a visual programming framework according to some embodiments.

FIG. 2A is a simplified diagram illustrating a computing device implementing the visual programming framework described in FIG. 1, according to some embodiments.

FIG. 2B is a simplified diagram illustrating a neural network structure, according to some embodiments.

FIG. 3 is a simplified block diagram of a networked system suitable for implementing the visual programming framework described in FIGS. 1-2B and other embodiments described herein.

FIG. 4 is an example logic flow diagram illustrating a method of visual programming based on the framework shown in FIGS. 1-3, according to some embodiments.

FIGS. 5-9 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

Language models may be used to answer questions about an image. One method for doing so is rather than directly generating an answer, the language model generates a code which may be executed and the result of the code provides information which the language model uses to respond to the question. This is called “Visual Programming.” Visual Programming, may be used as a method for tackling compositional reasoning tasks, a long-standing challenge for modern vision systems. Supervised methods may improve the performance of visual program synthesis by leveraging programs that yield correct results on training data. Nevertheless, a synthesized program may produce the correct output, even if its underlying logic is flawed. This leads to non-transferable and unreliable code, as well as a difficulty in generating good training data.

In view of the need for improved methods for visual programming, embodiments described herein provide for utilizing an LLM to automatically generate unit tests, comprising image descriptions and expected answers for specified queries. Further, text-to-image generation models are utilized to create images that align with the descriptions provided in each unit test. The unit tests may be used in a number of ways. In a first example, the system generates multiple programs, runs the unit tests on each of the programs, and responds to a question using the highest scoring generated program. In a second example, the system reverts to a baseline model in case of low scores on the unit tests. In a third example, unit tests are used for reinforcement learning of the model generating the code.

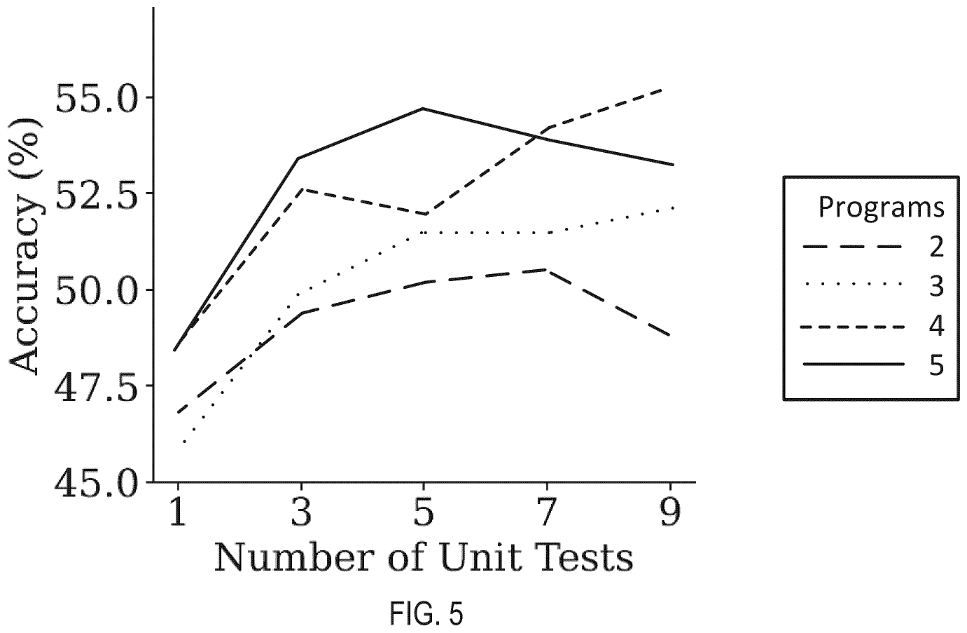

In some embodiments, visual unit tests may be applied in at least four scenarios: best program selection, answer refusal, re-prompting, and unsupervised reward formulations for reinforcement learning. Experiments with different base models across different datasets in visual question answering and image-text matching demonstrate that methods described herein improve model performance by 11.4% on average, and enables a smaller (e.g., 7B parameter) open source model to outperform gpt-4o-mini by an average of 7.7% and reduce the occurrence of programs that are correct for the wrong reasons by 40%. These results and additional results are described in more detail in FIGS. 5-9.

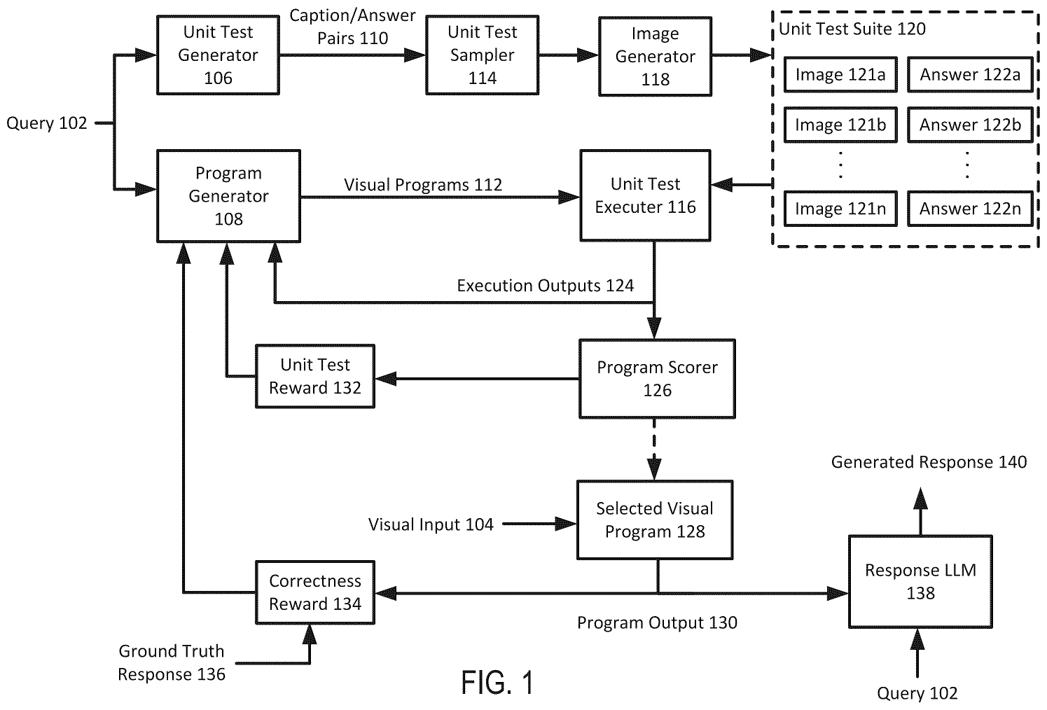

FIG. 1 is a simplified diagram illustrating a visual programming framework according to some embodiments. A visual input 104 (e.g., an image) and an input query 102 are provided, and response LLM 138 generates a generated response 140 as a response to the query 012 with reference to visual input 104. To aid response LLM 138 in generating the response 140, program generator 108 may generate one or more visual programs 112 based on the query. Program generator 108 may itself be an LLM (either the same LLM or a different LLM from response LLM 138), prompted to generate a visual program for answering query 102. Visual program 112 may utilize function calls that are made available for answering visual questions. For example, a software library may be prepared with visual functions (e.g., functions for identifying bounding boxes for objects in an image, etc.). The available functions may be provided to program generator 108 by including function descriptions in the prompt to program generator 108.

In an example, query 102 is “Is there an elephant in the blue water?” In response, program generator 108 may generate a visual program 112 that uses a first function call to identify the location of any elephants in the image, a second function that identifies the location of any blue water, and a third function comparing how many of the identified elephant locations overlap the water locations. In this example, there may be three elephants in the water in visual input 104, and the program may return a value of 3, or alternatively a Boolean value of TRUE.

In addition to programs that generate incorrect responses, some visual programs may generate a correct response, but for incorrect reasons, meaning the program may be less human interpretable, and prone to errors when applied with different visual inputs. To increase the accurate, interpretability, and portability of generated programs, a unit test suite may be generated for testing generated visual programs 112. A unit test generator 106 may generate, based on the query and a system prompt, caption/answer pairs 110. For example, a caption/answer pair may be: “Caption: ‘three elephants wading in blue water’ Answer: ‘3’.” Unit test generator 106 may also be an LLM (e.g., the same or different LLM from response LLM 138 and/or program generator 108), prompted to generate caption/answer pairs 110. An image generator 118 may be used to generate images 121 based on captions from caption/answer pairs 110. In some embodiments, a unit test sampler 114 is used to sample from caption/answer pairs 110, and only the sampled captions are generated into images 121. Unit test sampler 114 may be configured to sample in order to increase the diversity in answers and/or diversity in captions.

The result of generating the caption/answer pairs 110 and generating images based on the captions is unit test suite 120 which includes images 121a, 121b, up to 121n and corresponding answers 122a, 122b, up to 122n. Unit test executer 116 may apply generated visual programs 112 to images 121. Continuing the example above with the elephants, images 121a-121n may include various images including images of different numbers of elephants in blue water, elephants outside of water, giraffes in water, elephants in green water, etc. Each (or a sample of) images 121a-121n may be input to the various visual programs 112 to generate execution outputs 124.

A program scorer 126 may generates scores for each of the tested visual programs 112 based on the correspondence of the execution outputs with answers 122a-122n. In some embodiments, an exact match is required. In some embodiments, program scorer 126 uses fuzzy matching. In some embodiments, program scorer 126 further includes in the scores an adjustment based on compile errors and/or runtime errors. In some embodiments, the score for a visual program 112 is the sum of the number of unit tests passed by the visual program 112. In an example, program generator 108 generates multiple (e.g., 5) programs for a single query 102, and unit test suite is generated with multiple (e.g., 9) unit tests, and each of the unit tests is applied to each of the visual programs 112.

A system may select the visual program 112 based on the scores generated by program scorer 126. For example, selected visual program 128 may be the visual program 112 with the highest score. This may represent the visual program 112 that provided accurate execution outputs 124 for the most unit tests compared to the other generated visual programs 112. Visual input 104 may be input to selected visual program 128 to generate program output 130. In the elephant example, program output 130 may be “3” if there are three elephants in blue water in visual input 104. Program output 130 may be input to response LLM 138 in a prompt with query 102 in order to generate a human-readable generated response 140. For example, the query may be “Is there an elephant in the blue water?” A program may be generated to count the number of elephants, and the result of executing the program may be a Boolean value of TRUE. This value may be provided to response LLM 138 to generate a full response such as “Yes there is an elephant in the image.” This response may be displayed via a user interface (e.g., via UI application 312 of user device 310). In some embodiments, the program output 130 is able to be displayed as the final response to the query without further processing.

Additional steps may be performed in some embodiments to further improve results. In some embodiments, execution outputs 124 may be used to re-prompt program generator 108 to generate updated visual programs 112. For example, if the original prompt for program generate 108 included a system prompt describing the purpose of program generator 108, function descriptions, and query 102, then the re-prompt prompt may include those and additionally a description of the originally generated visual programs 112 and their corresponding execution outputs 124. This additional information may cause program generator 108 to improve subsequent visual programs 112 by helping to identify errors. Re-prompting may also provide information about compile or runtime errors of visual programs 112.

In some embodiments, program generator 108 may be trained (e.g., parameters updated via backpropagation) in response to a loss function or a reward. For example, a unit test reward 132 may be computed based on scored from program scorer 126. Another reward may be a correctness rewards 134 computed based on the correctness of the program output 130, determined by comparison to a ground truth response 136. Unit test reward 132 and/or correctness reward 134 may be utilized to train program generator 108 via reinforcement learning. An updated program generator 108 may be used to generated updated visual programs in order to ultimately proved generated response 140.

The process of generating responses from input queries 102 and visual inputs 104 may be further described as follows. Visual input 104 may be represented as v. Query 102 may be represented as q. The goal is to generate a program p that correctly answers q about v. Each program p∈ [symbol] is executed on the visual input v using an execution engine ϕ (e.g., unit test executer 116), yielding a predicted answer ŷ=ϕ(p, v). An objective is to select the program p* that is most likely to produce the correct answer y* to the query q about v, which may be represented as:

$${p}^{*} = arg max Pr ( ϕ ( p , v ) ≡ {y}^{*} ) \qquad ( 1 )$$

To assess the candidate programs, a unit test generator ψ (e.g., unit test generator 106) is employed to generate a set of unit tests [symbol] =ψ(q). Each unit test tᵢ∈ [symbol] consists of a test visual input vᵢ and the corresponding correct answer yᵢ to the query q on that input tᵢ=(vᵢ, yᵢ). For each candidate program p∈ [symbol] , the program is executed on all test inputs vᵢ to obtain outputs yᵢ=ϕ(p, vᵢ), for tᵢ∈

[symbol]

Given a program p to solve a query q, a goal is to generate a set of unit tests [symbol] comprising input images (e.g., images 121) and expected answers (e.g., answers 122). This process involves three steps: Candidate Unit Test Generation, Unit Test Sampling, and Image Generation.

Rather than generating images directly for unit tests, a system may first create image descriptions with expected answers (e.g., caption/answer pairs 110). This approach reduces computational overhead during the preliminary stage of unit test coverage sampling, after which images are generated only for those tests that are included in the final unit test suite [symbol] . In particular, a superset of M candidate unit tests may be first generated using the unit test generator ψ (e.g., unit test generator 106), which is implemented as an auto-regressive large language model. The unit test generator ψ can take both the query q and the program implementation p as inputs [symbol] =ψ(q, p) {t₁, t₂, . . . , t_{M}}. Each candidate unit test tᵢ consists of an image caption _{ci} and an expected answer _{yi}.

Unit tests verify the behavior of code and should ideally exhibit high isolation and coverage. In the context of visual programs, isolation is trivial since each program is a self-contained function. However, achieving high coverage—ensuring that the tests collectively exercise as much of the codebase as possible—is non-trivial due to the computational overhead of executing all candidate tests. To address this, coverage metrics may be tailored for visual programming unit tests, focusing on maximizing the diversity of both expected answers and visual inputs. The coverage sampler σ (e.g., unit test sampler 114) subsamples K pairs from [symbol] , forming the subset [symbol] .

Let Y={yᵢ|tᵢ∈ [symbol] } be the set of all expected answers in [symbol] . The answer diversity criterion may be defined as ensuring that for every possible answer y∈Y, there is at least one test tᵢ∈ [symbol] such that yᵢ=y:

$${∀}_{y} ∈ Y , ∃ {t}_{i} ∈ {𝒯}_{K} such that {y}_{i} ≡ y \qquad ( 2 )$$

To maximize the diversity of visual inputs without generating a burdensome number of images, operations are performed on image captions. An encoding function E may maps a caption c to a feature vector. With the aim to maximize the input diversity score σV ( [symbol] ), defined as the maximum pairwise distance between the encoded captions:

$${σ}_{v} ( {𝒯}_{K} ) = \begin{matrix}max \\ {t}_{i} , {t}_{j} ∈ {𝒯}_{K} , i \neq j\end{matrix} ‖ E ( {c}_{i} ) - E ( {c}_{j} ) ‖ \qquad ( 3 )$$

This encourages the selection of tests with diverse descriptions, which in turn is likely to yield diverse images. In some embodiments, the system begins by selecting one test for each possible answer to satisfy the answer diversity criterion (Equation (2)). Then, the system iteratively select additional tests to maximize σV ( [symbol] ) using the following criterion until K tests are selected, forming the subset [symbol] .

$${t}_{new} = arg \begin{matrix}max \\ t ∈ 𝒯 cand \backslash {𝒯}_{K}\end{matrix} \begin{matrix}max \\ {t}^{′} ∈ {𝒯}_{K}\end{matrix} ‖ E ( {c}_{t} ) - E ( {c}_{{t}^{′}} ) ‖ \qquad ( 4 )$$

For each selected unit test tᵢ=(cᵢ, yᵢ)∈ [symbol] , the system may generate the corresponding image vᵢ using a text-to-image model M (e.g., image generator 118) to yield the final unit-test suite [symbol] ={(M(cᵢ),yᵢ)|∀tᵢ∈ [symbol] }. In some embodiments, image generator M is a diffusion model. In some embodiments, image generator M utilizes automatically generated templates with phrases and bounding boxes for spatial conditioning. To provide these additional signals, an LLM may be prompted with in-context examples and the caption cᵢ to generate pairs of phrases and bounding boxes (phᵢ, bbᵢ) to feed into the text-to-image model: vᵢ=M(cᵢ, (phᵢ, bbᵢ)).

A program p* may be selected that succeeds on most unit tests by Equation (6), where the overall score S(p) is computed by an aggregator H over individual scores sₜ_{ᵢ}=h(ŷᵢ, yᵢ). For each program p and test ti=(vᵢ,yᵢ)∈ [symbol] , the system may execute p on vᵢ to obtain the predicted answer ŷᵢ=ϕ(p, vᵢ). A scoring function h may assign a score sₜ_{ᵢ} based on the program's output:

$${s}_{{t}_{i}} = h ( {\hat{y}}_{i} , {y}_{i} ) = \{ \begin{matrix}- {ϵ}_{r} , & if runtime error , \\ - {ϵ}_{c} , & if compilation error , \\ \{ {\hat{y}}_{i} ≡ {y}_{i} \} , & otherwise\end{matrix} \qquad ( 5 )$$

where ϵᵣ and ϵ_{c} are runtime and compilation error penalties and [symbol] is the indicator function. The individual scores sₜ_{ᵢ} are aggregated to compute an overall score S(p)=H({sₜ_{ᵢ}|tᵢ∈ [symbol] }). Here, H represents the averaging function. The program p* with the highest score is selected as the best candidate approximating Equation (1) by:

$${p}^{*} = arg \begin{matrix}max \\ p ∈ P\end{matrix} S ( p ) \qquad ( 6 )$$

Additional steps may be performed in some embodiments to further improve results, including best program selection, answer refusal, re-prompting, and reinforcement learning. For best program selection, given a set of candidate programs P={p₁, p₂, . . . , p_{N}} for a query q, a goal is to select the program p* that is most likely to produce the correct answer when executed on the visual input v. The unit test scores S(p) computed for each program p∈P (e.g., via program scorer 126) may be used to select the best program by solving the optimization problem in Equation (6).

For answer refusal, if the maximum unit test score S(p*) falls below a threshold θ, indicating low confidence in all candidate programs, the system may refuse to provide a programmatic answer. Instead, the system may retreat to an end-to-end fallback method. Formally, the decision rule may be represented as: If S(p*)<θ, refuse to answer and redirect. Otherwise, we proceed to execute the selected program p* on the original visual input v to obtain the final answer ŷ=ϕ(p*, v). The hyperparameter θ balances a trade-off between attempting to answer with potentially incorrect programs and deferring to a more reliable but less interpretable method.

For re-prompting, if all generated programs P fail to meet the threshold θ (i.e., max_{p∈P} S(p)<θ), the system may employ a re-prompting strategy to generate better candidate programs using feedback from unit tests:

$${P}^{′} = π ( {x}^{′} ( q ) + F ) \qquad ( 7 )$$

where: x′(q) is an adaptation of the original input containing the API, the query q, and in-context examples of unit-test-feedback corrections, and F is the feedback derived from unit test results, summarizing the discrepancies between expected and actual outputs, and π is the program generator (e.g., program generator 108). The best program p** may be selected from the new set P′ based on their unit test scores p**=arg max_{p′∈P′} S(p′). If S(p**)≥θ, p** may be executed on the original visual input v (e.g., visual input 104). Otherwise, the system may repeat the re-prompting process until a predefined number of iterations is reached. In some embodiments, the system may repeat the re-prompting process until the unit test scores a above a predetermined threshold, with a maximum number of allowed iterations.

For reinforcement learning (RL), one or more RL rewards may be computed based on visual unit tests, aiming not only to provide extra supervision but also curtail policy deterioration due to logically incorrect programs. The goal is to optimize a policy implemented as an autoregressive language model for program generation π_{w}, parameterized by w, by minimizing the reward-weighted loss over the dataset D, where each example consists of a visual input v, user query q, generated program p by the previous iteration's policy π_{w}_{^{itr-1}}, and ground truth answer y:

$$J ( w ) = {𝔼}_{( v , q , p , y ) ∼ D} [ R ( v , p , y ) {L}_{NLL} ( p , q ; w ) ] \qquad ( 8 )$$

$$where$$

$${L}_{NLL} ( p , q ; w ) = - {\sum }_{l = 1}^{L} log {π}_{w} ( {p}_{l} \vert {p}_{1 : l - 1} , x ( q ) )$$

is the negative log-likelihood loss on next token prediction and L is the sequence length. Further, a correctness reward (e.g., correctness reward 134) based on performance on the training set may be computed as:

$${R}_{Correct} ( v , p , y ) = \{ \begin{matrix}1 , & if ϕ ( p , v ) ≡ y , \\ 0 , & otherwise\end{matrix} \qquad ( 9 )$$

However, this approach can lead to sparse rewards and may falsely reward programs that are right for incorrect reasons. To address this issue a reward using feedback from the visual unit tests (e.g., unit test reward 132) may be formulated as:

$${R}_{ViUnit} ( v , p ) = \{ \begin{matrix}1 , & if S ( p ) \geq θ , \\ S ( p ) , & otherwise\end{matrix} \qquad ( 10 )$$

where θ is a passing threshold. The system may terminate policy iteration on declining reward. One may assume that an optimal policy will keep increasing an optimal reward function R*. Thus, when a proxy reward R declines (i.e., regret increases), there are theoretical guarantees that the system is not far from the optimal policy that can be learned under R.

### Computer and Network Environment

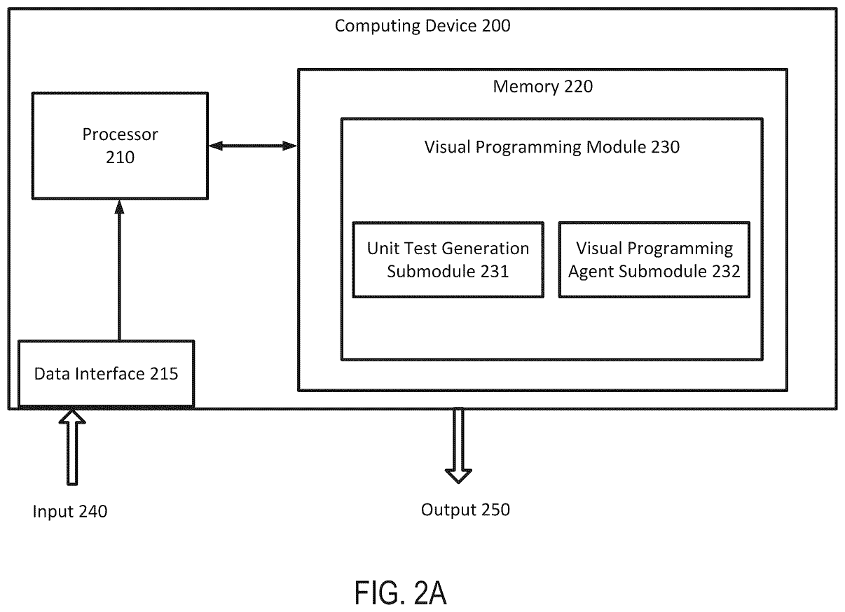

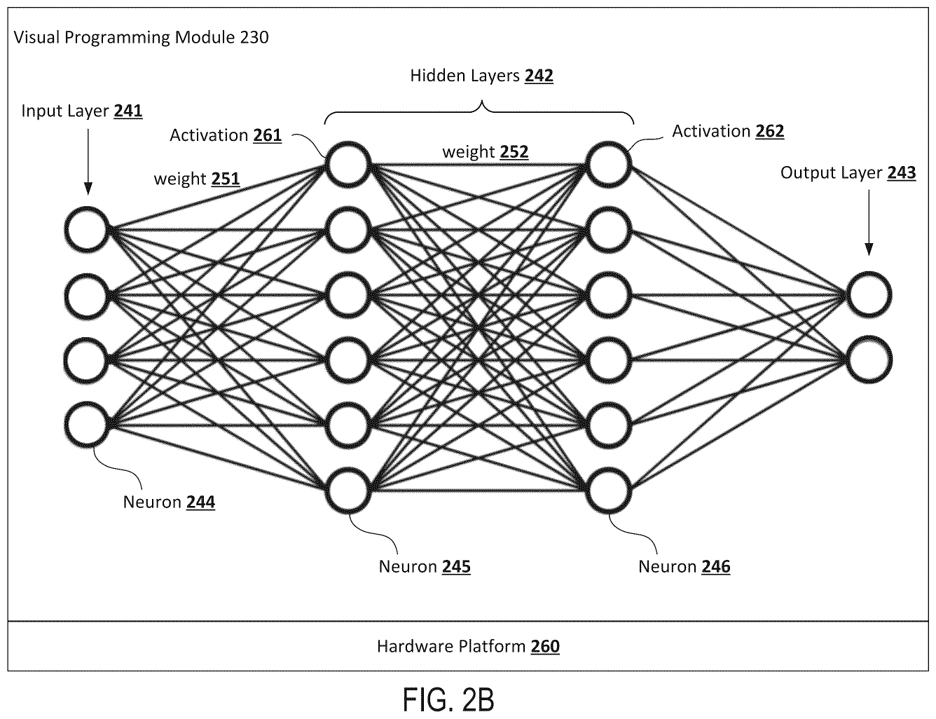

FIG. 2A is a simplified diagram illustrating a computing device implementing the visual programming framework described in FIG. 1, according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In another embodiment, processor 210 may comprise multiple microprocessors and/or memory 220 may comprise multiple registers and/or other memory elements such that processor 210 and/or memory 220 may be arranged in the form of a hardware-based neural network, as further described in FIG. 2B.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for visual programming module 230 that may be used to implement and/or emulate the systems and models, and/or to implement any of the methods described further herein. visual programming module 230 may receive input 240 such as an input training data (e.g., queries with or without corresponding visual inputs, known-good programs, known-good program outputs, or known-good responses) via the data interface 215 and generate an output 250 which may be one or more visual programs, visual program scores, an output of a program, or a response to a query based on the output of a generated program.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as queries, from a user via the user interface.

In some embodiments, the visual programming module 230 is configured to perform visual programming tasks as described herein including in some embodiments generating visual programs, scoring the outputs of the visual programs, selecting a visual program, generating an output of the selected visual program based on a visual input, training the visual program generator, etc. The visual programming module 230 may further include unit test generation submodule 231 configured to generate unit tests as described herein. The visual programming module 230 may further include visual programming agent submodule 232 configured to generate visual programs and utilize the visual programs to generate a response to a query as described herein.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 2B is a simplified diagram illustrating the neural network structure implementing the visual programming module 230 described in FIG. 2A, according to some embodiments. In some embodiments, the visual programming module 230 and/or one or more of its submodules 231-232 may be implemented at least partially via an artificial neural network structure shown in FIG. 2B. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 240 in FIG. 2A), such as a query. The number of nodes (neurons) in the input layer 241 may be determined by the dimensionality of the input data (e.g., the length of a vector of the query). Each node in the input layer represents a feature or attribute of the input.

The hidden layers 242 are intermediate layers between the input and output layers of a neural network. It is noted that two hidden layers 242 are shown in FIG. 2B for illustrative purpose only, and any number of hidden layers may be utilized in a neural network structure. Hidden layers 242 may extract and transform the input data through a series of weighted computations and activation functions.

For example, as discussed in FIG. 2A, the visual programming module 230 receives an input 240 of a query and a visual input and transforms the input into an output 250 of one or more visual programs, visual program scores, an output of a program, or a response to a query based on the output of a generated program. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the visual programming module 230 and/or one or more of its submodules 231-232 may comprise the transformative neural network structure of layers of neurons, and weights and activation functions describing the non-linear transformation at each neuron. Such a neural network structure is often implemented on one or more hardware processors 210, such as a graphics processing unit (GPU).

In one embodiment, the visual programming module 230 and its submodules 231-232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the visual programming module 230 and its submodules 231-232 may be implemented by hardware, software and/or a combination thereof. For example, the visual programming module 230 and its submodules 231-232 may comprise a specific neural network structure implemented and run on various hardware platforms 260, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 260 used to implement the neural network structure is specifically configured based on factors such as the complexity of the neural network, the scale of the tasks (e.g., training time, input data scale, size of training dataset, etc.), and the desired performance.

In another embodiment, some or all of layers 241, 242, 243 and/or neurons 242, 245, 246, and operations there between such as activations 261, 262, and/or the like, of the visual programming module 230 and its submodules 231-232 may be realized via one or more ASICs. For example, each neuron 242, 245 and 246 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the visual programming module 230 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based visual programming module 230 and one or more of its submodules 231-232 may be trained by iteratively updating the underlying parameters (e.g., weights 251, 252, etc., bias parameters and/or coefficients in the activation functions 261, 262 associated with neurons) of the neural network based on the loss or reward as described herein. For example, during forward propagation, the training data such as queries with or without corresponding visual inputs, known-good programs, known-good program outputs, or known-good responses are fed into the neural network. The data flows through the network's layers 241, 242, with each layer performing computations based on its weights, biases, and activation functions until the output layer 243 produces the network's output 250. In some embodiments, output layer 243 produces an intermediate output on which the network's output 250 is based.

The output generated by the output layer 243 is compared to the expected output from the training data, to compute a loss function or reward as described in FIG. 1 that measures the discrepancy between the predicted output and the expected output. For example, the reward may be the correctness reward described in FIG. 1. Given the loss or reward, a gradient is computed with respect to each weight of each layer individually. Such gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

In one embodiment, the neural network based visual programming module 230 and one or more of its submodules 231-232 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like, such as in equation (9) or (10). These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

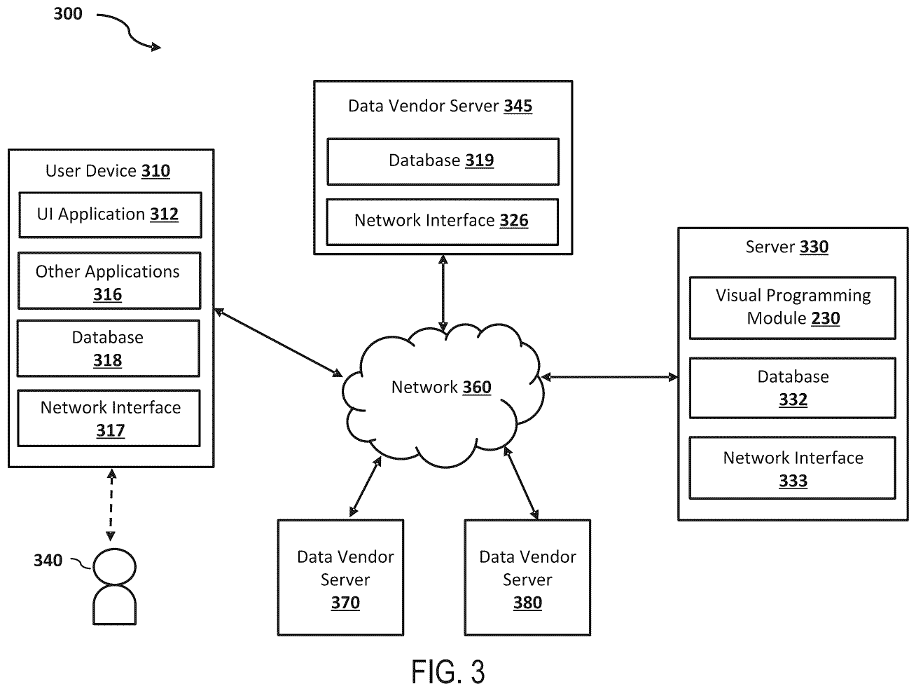

In some embodiments, visual programming module 230 and its submodules 231-232 may be housed at a centralized server (e.g., computing device 200) or one or more distributed servers. For example, one or more of visual programming module 230 and its submodules 231-232 may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen queries and visual inputs.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in visual programming. With an improvement in visual programming, applications in fields such as quality assurance, process automation, IT, code generation, etc. is thereby improved.

FIG. 3 is a simplified block diagram of a networked system 300 suitable for implementing the visual programming framework described in FIGS. 1-2B and other embodiments described herein. In one embodiment, system 300 includes the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating a response from the server 330 and display the message via the UI application 312. In other embodiments, user device 310 may include additional or different modules having specialized hardware and/or software as required.

In one embodiment, UI application 312 may communicatively and interactively generate a UI for an AI agent implemented through the visual programming module 230 (e.g., an LLM agent) at server 330. In at least one embodiment, a user operating user device 310 may enter a user utterance, e.g., via text or audio input, such as a question, uploading a document, and/or the like via the UI application 312. Such user utterance may be sent to server 330, at which visual programming module 230 may generate a response via the process described in FIGS. 1-2B. The visual programming module 230 may thus cause a display of a response at UI application 312 and interactively update the display in real time with the user utterance.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view responses, visuals, etc.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including queries with or without corresponding visual inputs, known-good programs, known-good program outputs, or known-good responses to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the visual programming module 230 and its submodules described in FIG. 2A. In some implementations, visual programming module 230 may receive data from database 319 at the data vendor server 345 via the network 360 to generate one or more visual programs, visual program scores, an output of a program, or a response to a query based on the output of a generated program. The generated outputs may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the visual programming module 230. In one implementation, the database 332 may store previously generated outputs, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Work Flows

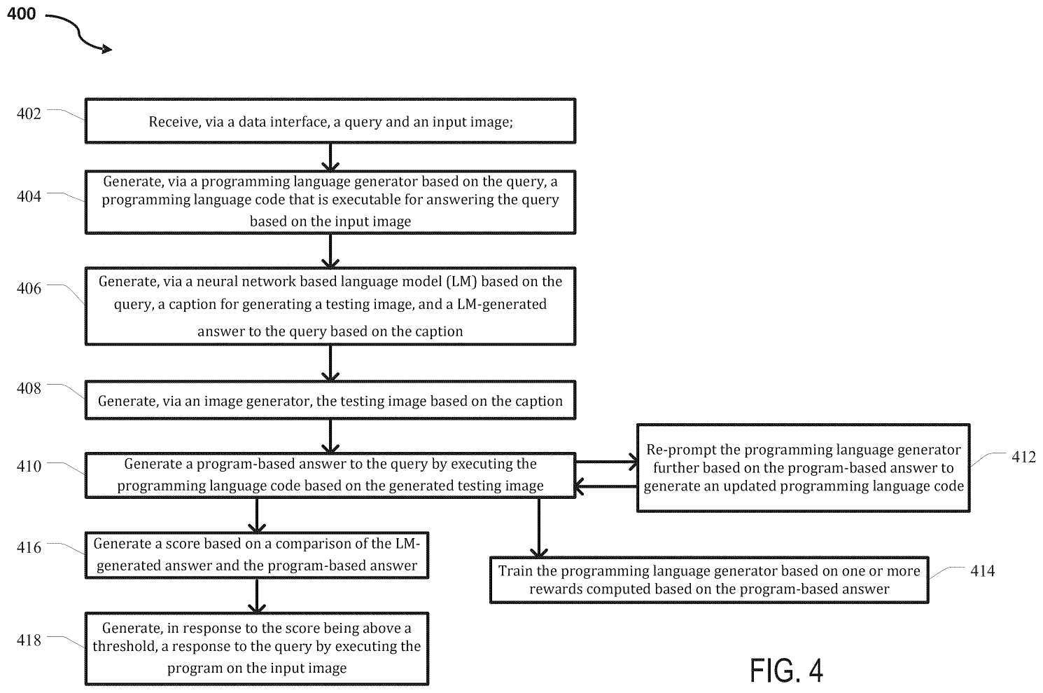

FIG. 4 is an example logic flow diagram illustrating a method of visual programming based on the framework shown in FIGS. 1-3, according to some embodiments described herein. One or more of the processes of method 400 may be implemented, at least in part, in the form of executable code stored on non-transitory, tangible, machine-readable media that when run by one or more processors may cause the one or more processors to perform one or more of the processes. In some embodiments, method 400 corresponds to the operation of the visual programming module 230 (e.g., FIGS. 2A and 3) that performs visual programming including the automatic generation of unit tests.

In some embodiments, method 400 is performed by a system such as computing device 200, user device 310, server 330, or another device or combination of devices. Inputs (e.g., queries and/or input images) may be received via a data interface such as data interface 215, network interface 317, network interface 333, or via a data interface that is integrated with a device. For example UI Application 312 may receive user inputs via a text input interface (e.g., keyboard), audio input (e.g., microphone), video interface (e.g., camera), or other interface for receiving user inputs (e.g., a mouse or touch display).

As illustrated, the method 400 includes a number of enumerated steps, but aspects of the method 400 may include additional steps before, after, and in between the enumerated steps. In some aspects, one or more of the enumerated steps may be omitted or performed in a different order.

At step 402, a system receives, via a data interface, a query (e.g., query 102) and an input image (e.g., visual input 104).

At step 404, the system generates, via a programming language generator (e.g., program generator 108) based on the query, a programming language code (e.g., visual program 112) that is executable for answering the query based on the input image.

At step 406, the system generates, via a neural network based language model (LM) (e.g., unit test generator 106) based on the query, a caption for generating a testing image, and a LM-generated answer to the query based on the caption (e.g., caption/answer pair 110).

At step 408, the system generates, via an image generator (e.g., image generator 118), the testing image (e.g., image 121a) based on the caption.

At step 410, the system generates a program-based answer to the query (e.g., execution output 124) by executing the programming language code based on the generated testing image.

As described in FIG. 1, in different embodiments different applications may be accomplished, alone or in combination, including the steps described below.

At step 412, the system re-prompts the programming language generator further based on the program-based answer to generate an updated programming language code. The method may continue at step 410 by executing the updated programming language code. This process may be iterated a number of times. In some embodiments, the number of iterations is a predetermined number. In some embodiments, the number of iterations is dependent on the updated program not having any errors, or achieving a certain accuracy based on unit test performance.

At step 414, the system trains the programming language generator based on one or more rewards computed based on the program-based answer (e.g., unit test reward 132 and/or correctness reward 134). The system may then use the trained programming language generator to generate additional programs, similar to re-prompting at step 412, however, without necessarily using an updated prompt.

At step 416, the system generates a score (e.g., via program scorer 126) based on a comparison of the LM-generated answer and the program-based answer. In some embodiments, the system conducts additional unit tests (e.g., generates additional images with answers, and runs the programming code on them), wherein the score is further based on the additional unit tests. For example, the score may be the number of unit tests passed correctly. In some embodiments, the system generates additional programming language codes, and generates an associated second set of scores with the additional programming language codes. Sampling from the additional unit tests may be done for diversity of captions, and/or diversity of answers. Generating the second set of scores may be performed using only the sampled unit tests of the additional unit tests.

At step 418, the system generates, in response to the score being above a threshold, a response to the query by executing the program (e.g., selected visual program 128) on the input image. In some embodiments, generating the response to the query may include selecting the programming language code used in generating the response based on the score and the second set of scores. For example, the programming code with the highest score may be selected (e.g., the threshold may be the second highest score). In some embodiments, the system samples from the additional unit tests rather than running all the unit tests. In some embodiments, generating the response to the query is further based on a compilation error and/or a runtime error of the programming language code. For example, the programming language code may be selected based on a score, and the score may be determined at least partially based on a compilation error or a runtime error. In some embodiments, in response to the score being below a threshold, the system generates a response to the query by executing a baseline program on the input image. In some embodiments, the system generates a baseline response, for example stating that it is unable to confidently provide an answer.

In some embodiments, the response to the query is provided to an LLM (e.g., response LLM) in order to generate a human-readable response (e.g., generated response 140) to the query. For example, the query may be “how many elephants are in this image?” A program may be generated to count the number of elephants, and the result of executing the program may be a number, e.g., “3”. This value may be provided to an LLM to generate a full response such as “there are 3 elephants in the image.” This response may be displayed via a user interface.

In some embodiments, method 400 is applicable in a variety of applications. For example, the query received may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 400, the neural network based artificial agent may improve technology in the respective technical field in healthcare and diagnostics, education and personalized learning, software development and code assistance, content creation, autonomous system (such as autonomous driving, etc.), and/or the like.

For example, when the query includes a query to identify an information technology (IT) anomaly relating to a usage of an IT component such as a network gateway, a router, an online printer, and/or the like, by performing method 400 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

In another example, the query is related to identifying specific types of objects in an image. By allowing for the automatic generation of a visual program that can accurately answer a visual question, this allows for flexibility in the system where a user may adjust what exactly is being looked for without requiring the user to be able to figure out how to code the program themselves. For example, a video monitoring system equipped with a system as described herein may monitor the video feed of a doorbell camera at a front door of a home. The user may specify that they want to be alerted if a package of a certain size is left on their doorstep. The query (either generated based on a user input or directly entered by a user) for example may be “is there a package larger than the stool” referencing a stool also in the image for comparison. Later, the user may desire to change the query to only alert if there is more than one package, with a query such as “is there more than one package on the doorstep?” Since the system improves generated programs via the automatically generated unit tests and other functions described herein, the generated program as a result of the query is more likely to not only provide an accurate result, but do so for the correct reasons, increasing the odds of the program generating the correct output for different inputs (e.g., different size packages in the image). The video monitoring system described here is exemplary, and applications of automatically generating visual programs may be applied in a number of similar and dissimilar ways.

### Example Results

FIGS. 5-9 represent exemplary test results using embodiments described herein. Datasets used in the experiments include GQA as described in Hudson et al., GQA: A new dataset for real-world visual reasoning and compositional question answering, Proceedings of the IEEE/CVF conference on computer vision and pattern recognition, pp. 6700-6709, 2019; SugarCREPE as described in Hsieh et al., Sugarcrepe: Fixing hackable benchmarks for vision-language compositionality, Advances in neural information processing systems, 36, 2024; and Winoground as described in Thrush et al., Winoground: Probing vision and language models for visio-linguistic compositionality, IEEE/CVF Conference on Computer Vision and Pattern Recognition (CVPR), pp. 5228-5238, IEEE Computer Society, 2022. For GQA, accuracy was calculated using an implementation as described in Suris et al, Vipergpt: Visual inference via python execution for reasoning, Proceedings of the IEEE/CVF International Conference on Computer Vision, pp. 11888-11898, 2023. This implementation standardizes and compares generated answers for exact matches. The experimental setup incorporates training and sampled testing splits, specifically testing on 502 examples from the GQA balanced-val split and training on 1022 examples from the balanced-train split, with 10 samples per question group. In SugarCREPE, experiments utilized 788 examples for training by subsampling approximately 10% of the dataset balanced across question types, excluding the validation split. The validation subset consists of 560 examples and includes both positive and negative image-text pairings from 40 samples from each of the 7 question types. The full Winoground dataset is used, encompassing all possible positive and negative pairings for a total of 1600 test examples, with the SugarCREPE dataset employed for training purposes.

Experiments were performed against baseline models. The base setup prompted an LLM to generate a single program per query, which was executed to retrieve a response. To leverage multiple programs, performance was compared with selecting the most common answer across executed programs if one exists. To evaluate the effectiveness of unit-test incorporation in program correction via unit-test re-prompting, performance was benchmarked against a method that leverages error-traces as feedback. The baseline unsupervised unit-test RL reward formulation was tested against the supervised correctness reward.

FIG. 5 illustrates the accuracy of generated programs based on the number of unit tests utilized, on the GQA dataset. Each line represents a different number of candidate programs generated. As illustrated, increasing both the number of unit tests and the number of candidate programs improves accuracy on the GQA dataset. Accuracy rises substantially with the addition of unit tests, particularly from 1 to 5 tests, after which gains diminish. Higher number of programs (e.g., 4 or 5) consistently yield better accuracy compared to fewer programs, underscoring the benefit of exploring multiple candidate solutions.

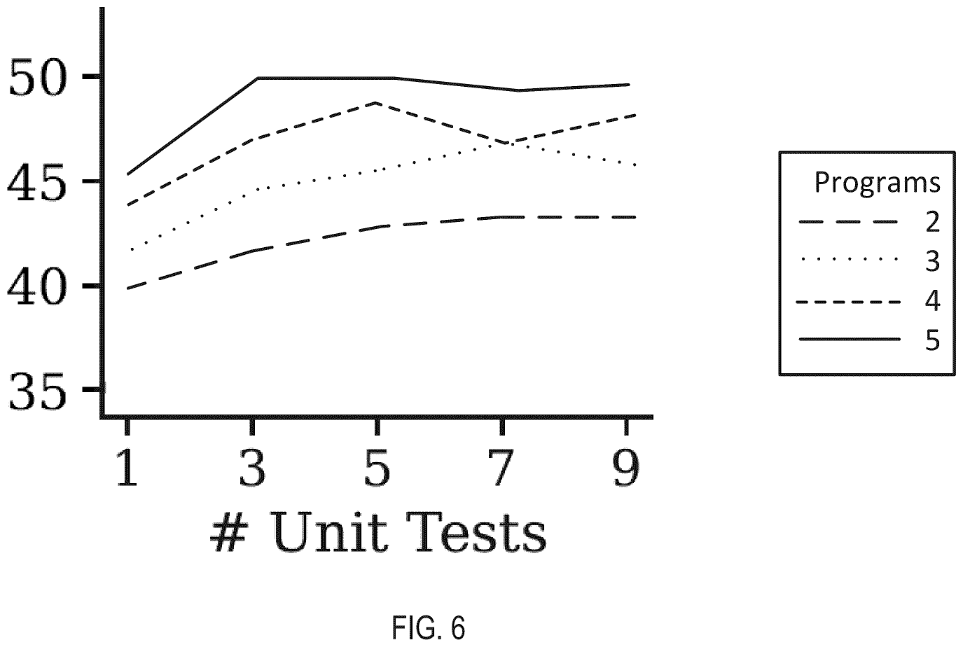

FIG. 6 illustrates the accuracy of generated programs based on the number of unit tests utilized, on the Winoground dataset. Each line represents a different number of candidate programs generated. As illustrated, increasing both the number of unit tests and the number of candidate programs improves accuracy on the Winoground dataset. Accuracy rises substantially with the addition of unit tests, particularly from 1 to 5 tests, after which gains diminish. Higher number of programs (e.g., 4 or 5) consistently yield better accuracy compared to fewer programs, underscoring the benefit of exploring multiple candidate solutions.

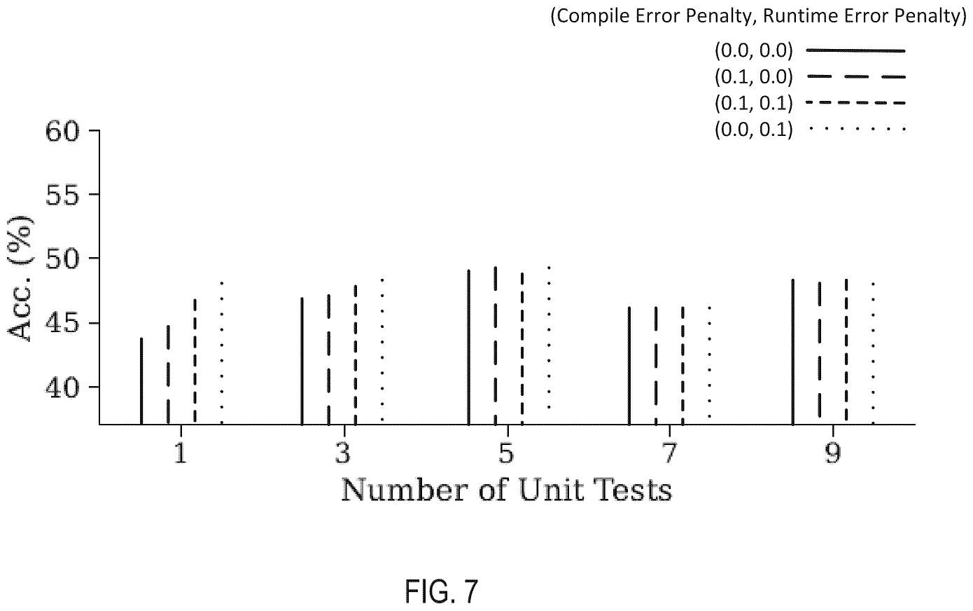

FIG. 7 illustrates program accuracy for different numbers of unit tests with 4 programs and varying penalties on compilation and runtime errors, on the GQA dataset. While the effect becomes negligible in higher-resource configurations with more programs and unit tests, error penalties prove beneficial in lower-resource settings. In these scenarios, they help prioritize the selection of executable programs, thereby improving performance.

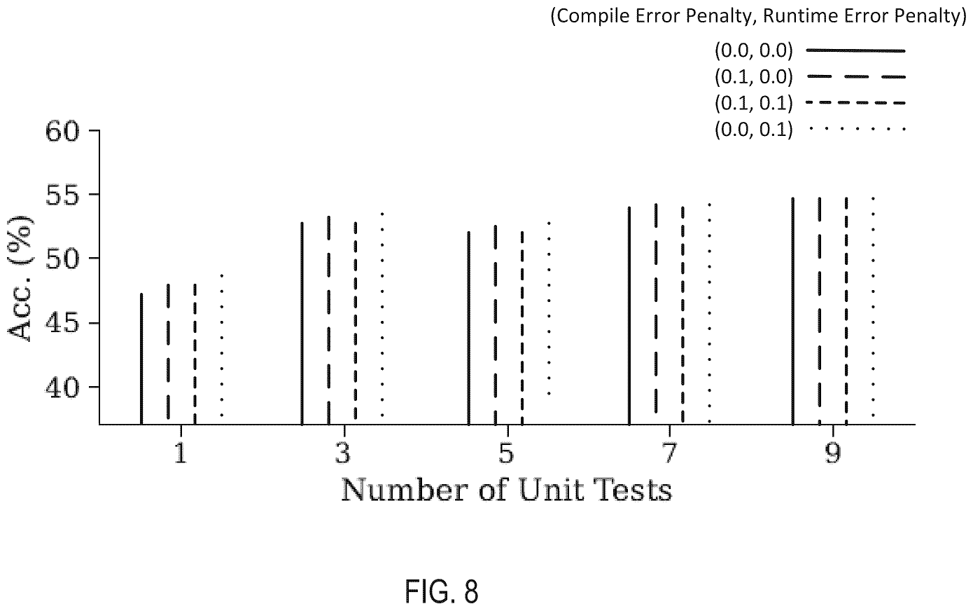

FIG. 8 illustrates program accuracy for different numbers of unit tests with 4 programs and varying penalties on compilation and runtime errors, on the Winoground dataset. While the effect becomes negligible in higher-resource configurations with more programs and unit tests, error penalties prove beneficial in lower-resource settings. In these scenarios, they help prioritize the selection of executable programs, thereby improving performance. Notably, runtime error penalties are more impactful for GQA (as shown in FIG. 7), whereas compilation error penalties play a larger role in Winoground (as shown in FIG. 8). This difference may be due to the higher complexity of Winoground programs, which are more prone to compilation errors.

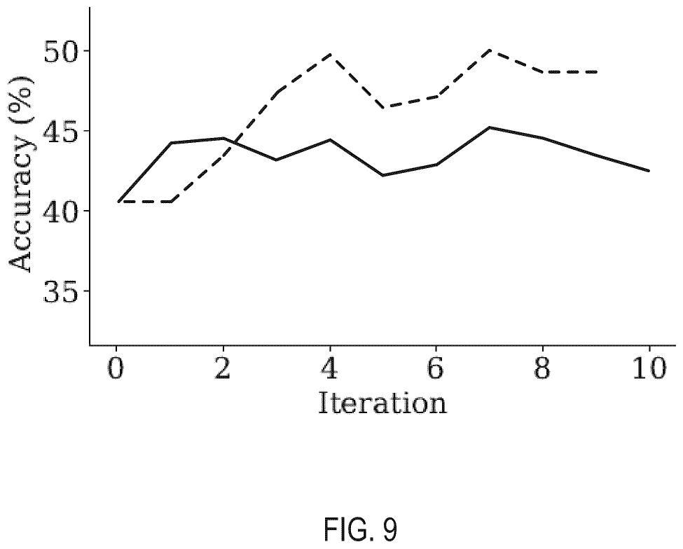

FIG. 9 illustrates accuracy of programs using the GQA dataset with increasing numbers of reinforcement learning iterations. The solid line represents performance without unit tests, and the dashed line represents performance with 5 unit tests.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of building an artificial intelligence (AI) agent for generating a response to a query related to an input image, the method comprising:
operating the AI agent based on a programming language generator and a neural network based language model (LM) on one or more processors;
receiving, via a data interface, the query and the input image;
generating, via the programming language generator based on the query, a programming language code that is executable for answering the query based on the input image;
conducting a unit test comprising:
generating, via the neural network based language model (LM) based on the query, a caption for generating a testing image, and a LM-generated answer to the query based on the caption,
generating, via an image generator, the testing image based on the caption,
generating a program-based answer to the query by executing the programming language code based on the generated testing image, and
generating a score based on a comparison of the LM-generated answer and the program-based answer; and
generating, in response to the score being above a threshold, a response to the query by executing the programming language code on the input image.

2. The method of claim 1, further comprising:
conducting additional unit tests, wherein the score is further based on the additional unit tests.

3. The method of claim 2, further comprising:
generating additional programming language codes; and
generating a second set of scores associated with the additional programming language codes,
wherein the generating the response to the query includes selecting the programming language code used in generating the response based on the score and the second set of scores.

4. The method of claim 2, further comprising:
sampling from the additional unit tests for diversity of captions or diversity of answers,
wherein the generating the second set of scores is performed using only the sampled unit tests of the additional unit tests.

5. The method of claim 1, wherein the generating the response to the query is further based on a compilation error or a runtime error of the programming language code.

6. The method of claim 1, further comprising:
training the programming language generator based on a reward associated with the unit test.

7. The method of claim 1, further comprising:
generating, in response to the score being below the threshold, a response to the query by executing a baseline program on the input image.

8. A system for building an artificial intelligence (AI) agent for generating a response to a query related to an input image, the system comprising:
a memory that stores the AI agent and a neural network based language model (LM) and a plurality of processor executable instructions;
a communication interface that receives the query and the input image; and
one or more hardware processors that read and execute the plurality of processor-executable instructions from the memory to perform operations comprising:
generating, via the programming language generator based on the query, a programming language code that is executable for answering the query based on the input image;
conducting a unit test comprising:
generating, via the neural network based language model (LM) based on the query, a caption for generating a testing image, and a LM-generated answer to the query based on the caption,
generating, via an image generator, the testing image based on the caption,
generating a program-based answer to the query by executing the programming language code based on the generated testing image, and
generating a score based on a comparison of the LM-generated answer and the program-based answer; and
generating, in response to the score being above a threshold, a response to the query by executing the programming language code on the input image.

9. The system of claim 8, the operations further comprising:
conducting additional unit tests, wherein the score is further based on the additional unit tests.

10. The system of claim 9, the operations further comprising:
generating additional programming language codes; and
generating a second set of scores associated with the additional programming language codes,
wherein the generating the response to the query includes selecting the programming language code used in generating the response based on the score and the second set of scores.

11. The system of claim 9, the operations further comprising:
sampling from the additional unit tests for diversity of captions or diversity of answers,
wherein the generating the second set of scores is performed using only the sampled unit tests of the additional unit tests.

12. The system of claim 8, wherein the generating the response to the query is further based on a compilation error or a runtime error of the programming language code.

13. The system of claim 8, the operations further comprising:
training the programming language generator based on a reward associated with the unit test.

14. The system of claim 8, the operations further comprising:
generating, in response to the score being below the threshold, a response to the query by executing a baseline program on the input image.

15. A non-transitory machine-readable medium comprising a plurality of machine-executable instructions which, when executed by one or more processors, are adapted to cause the one or more processors to perform operations comprising:
receiving, via a data interface, a query and an input image;
generating, via the programming language generator based on a query, a programming language code that is executable for answering the query based on the input image;
conducting a unit test comprising:
generating, via a neural network based language model (LM) based on the query, a caption for generating a testing image, and a LM-generated answer to the query based on the caption,
generating, via an image generator, the testing image based on the caption,
generating a program-based answer to the query by executing the programming language code based on the generated testing image, and
generating a score based on a comparison of the LM-generated answer and the program-based answer; and
generating, in response to the score being above a threshold, a response to the query by executing the programming language code on the input image.

16. The non-transitory machine-readable medium of claim 15, the operations further comprising:
conducting additional unit tests, wherein the score is further based on the additional unit tests.

17. The non-transitory machine-readable medium of claim 16, the operations further comprising:
generating additional programming language codes; and
generating a second set of scores associated with the additional programming language codes,
wherein the generating the response to the query includes selecting the programming language code used in generating the response based on the score and the second set of scores.

18. The non-transitory machine-readable medium of claim 16, the operations further comprising:
sampling from the additional unit tests for diversity of captions or diversity of answers,
wherein the generating the second set of scores is performed using only the sampled unit tests of the additional unit tests.

19. The non-transitory machine-readable medium of claim 15, wherein the generating the response to the query is further based on a compilation error or a runtime error of the programming language code.

20. The non-transitory machine-readable medium of claim 15, the operations further comprising:
training the programming language generator based on a reward associated with the unit test.
